(19) United States
(12) Patent Application Publication
(10) Pub. No.: US 2025/0178141 A1
(43) Pub. Date: Jun. 5, 2025

(54) LOCAL LOW PLASTICITY BURNISHING FOR MANUFACTURE OF ENGINE COMPONENTS WITH COMPLEX ORGANIC STIFFENING PATTERNS

(71) Applicant: General Electric Company, Evendale, OH (US)

(72) Inventors: Leonardo Ajdelsztajn, Niskayuna, NY (US); Jeffrey Jon Schoonover, Niskayuna, NY (US); Jonathan H. Kerner, Lynn, MA (US)

(21) Appl. No.: 18/955,555

(22) Filed: Nov. 21, 2024

Related U.S. Application Data
(60) Provisional application No. 63/605,269, filed on Dec. 1, 2023.

(51) Int. Cl. B23P 17/00

(52) U.S. Cl. CPC B23P 17/00

(57) ABSTRACT

Methods, apparatus, systems and articles of manufacture are disclosed for a framework and associated process to form an engine component. Examples provide localized, low plasticity burnishing or deformation to form complex, organic stiffening patterns. An example apparatus includes a frame to hold a part; a tool to apply a force to the part; and a support structure to be positioned opposite the tool to support the part when the force is applied to the part by the tool.

### CROSS-REFERENCE TO RELATED APPLICATIONS

This patent arises from U.S. Provisional Patent Application No. 63/605,269, filed on Dec. 1, 2023. Priority is claimed to U.S. Provisional Patent Application No. 63/605,269, which is incorporated herein by reference in its entirety.

### FIELD OF THE DISCLOSURE

This disclosure relates generally to gas turbines and, more particularly, to unit cell structures including stiffening patterns.

### BACKGROUND

A gas turbine engine generally includes, in serial flow order, an inlet section, a compressor section, a combustion section, a turbine section, and an exhaust section. In operation, air enters the inlet section and flows to the compressor section where one or more axial compressors progressively compress the air until it reaches the combustion section, thereby creating combustion gases. The combustion gases flow from the combustion section through a hot gas path defined within the turbine section and then exit the turbine section via the exhaust section.

A gas turbine engine such as a turbofan includes a bypass duct wholly or partially surrounding a core turbine engine of the turbofan including the compressor section, the combustion section, the turbine section, and the exhaust section. The operation and orientation of the turbofan during flight of the aircraft induce an overturning moment, axial compressive forces, and/or torsion on components and/or structures the turbofan such as a bypass duct, fan casing, and/or cowl, etc.

### BRIEF DESCRIPTION OF THE DRAWINGS

FIG. 1A is an example apparatus to form a stiffening pattern in a part.

FIG. 1B is an example apparatus to form a stiffening pattern in a part.

FIG. 2 is a flowchart representative of an example method of forming a stiffening pattern in the part.

FIG. 3 is a perspective view of an isogrid structure.

FIG. 4A is a perspective view of an example first panel including a stiffening pattern for unit cell structures.

FIG. 4B is a front view of the first panel of FIG. 4A showing an example cutting line A-A and an example cutting line B-B.

FIG. 5 is a cross-section of the first panel of FIG. 4A taken along the A-A cutting line of FIG. 4B.

FIG. 6 is another cross-section of the first panel of FIG. 4A taken along the B-B cutting line of FIG. 4B.

FIG. 7 is another perspective view of the first panel of FIG. 4A showing the reverse side of the first panel.

FIG. 8 is a perspective view of an example cylindrical structure including the stiffening pattern for unit cell structures of FIGS. 4A-7.

FIG. 9A is a perspective view of an example second panel including alternate nodes for use in the stiffening patterns for unit cell structures of FIGS. 4A-8.

FIG. 9B is a front view of the second panel of FIG. 9A showing an example cutting line C-C.

FIG. 9C is a cross-section of the second panel of FIG. 9A taken along the C-C cutting line of FIG. 9B.

FIG. 10A is a front view of an example cylindrical structure model including the stiffening patterns of FIGS. 4A-9C.

FIG. 10B is a front view of an example cylindrical structure model including the stiffening patterns of FIGS. 4A-9C, wherein the unit cells vary in size throughout the structure.

FIG. 10C is a front view of an example cylindrical structure model including the stiffening patterns of FIGS. 4A-9C, wherein the unit cells vary in geometric shape throughout the structure.

FIG. 11 is a block diagram of an example processor platform structured to execute the instructions of FIG. 2 to drive and/or otherwise control the example apparatus of FIGS. 1A-1B to form an example structure including the stiffening pattern for unit cell structures of FIGS. 3-10C.

The figures are not to scale. Instead, the thickness of the layers or regions may be enlarged in the drawings. In general, the same reference numbers will be used throughout the drawing(s) and accompanying written description to refer to the same or like parts. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Stating that any part is in “contact” with another part means that there is no intermediate part between the two parts. Although the figures show layers and regions with clean lines and boundaries, some or all of these lines and/or boundaries may be idealized. In reality, the boundaries and/or lines may be unobservable, blended, and/or irregular.

Descriptors “first,” “second,” “third,” etc., are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Engine components and other structures can be formed of a plurality of materials. However, different materials involve different weights and different methods of manufacture, often resulting in added weight, complexity, time, and/or associated error. Isopanel structures, for example, can be very difficult to manufacture using traditional methods. For example, sheet metal forming can be used but cannot form a full engine casing. Instead, a flat sheet is formed, which can potentially be used to make half a case. Two halves can then be bolted together at a split line to form a full case. Such an approach, however, introduces potential for faults/failure along the split line, added complexity in the assembly, additional weight in the bolts, and potential for error in the assembly. Manufacture of axisymmetric parts, such as cases, etc., is difficult with such flat stock-based techniques. Certain examples provide manufacture of a full case and/or other engine component, axisymmetric or otherwise, with no split line.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Gas turbine engines such as turbofans of the high-bypass type and low-bypass type experience operational loads, causing overturning moments, compressive forces, and torsion during flight. The overturning moment (e.g., a rotational force that causes a turbofan structure to tip or rotate) is a bending moment from fore to aft of a turbofan induced due to the orientation and operation of an aircraft. Axial compressive forces (e.g., forces acting along an axis of the turbofan structure causing the structure to shorten or crush) are also induced in the turbofan due to the orientation and operation of the aircraft during flight. Torsion (e.g., twisting of a turbofan structure due to an applied torque) is induced in the turbofan, for example, due to the operation of internal components of the turbofan (e.g., due to rotation of compressor rotors and turbine rotors, etc.). Cylindrical or partially cylindrical structural components (e.g., backbone structures, structures, etc.) of the turbofan, such as a bypass duct, a fan casing, a compressor casing, cowls, and/or a nacelle, particularly experience the overturning moment, compressive forces, and/or torsion. The overturning moment, axial compressive forces, and torsion can increase during an imbalance event such as the loss of a fan blade of a fan, a compressor blade of a compressor, and a turbine blade of a turbine of the turbofan. Further, the overturning moment, axial compressive forces, and torsion can increase due to inertial loads caused by harsh landings, aircraft maneuvers involving high acceleration (e.g., high gravitational force equivalent (g-force)), etc.

The cylindrical structures (e.g., components) of the turbofan such as the bypass duct, the fan casing, the compressor casing, the engine cowls, the nacelle, exhaust, and/or afterburner, etc., include one or more walled structures (e.g., shells). The overturning moment, compressive forces, and/or torsion can cause stresses that lead to compression, out-of-plane deformation, and/or buckling of the walled structures of the cylindrical structures and can lead to failure of the component. To prevent deformation and buckling due to the stresses induced by the overturning moment, compressive forces, and/or torsion, it is desirable to increase the stiffness of the structures. The overturning moment, compressive forces, and/or torsion induce stresses in in the cylindrical structures along the circumferential direction, the axial direction, and at angles therebetween. Accordingly, it is desirable to increase stiffness of the cylindrical engine structures in an isotropic manner to protect against deformation and bucking in all directions.

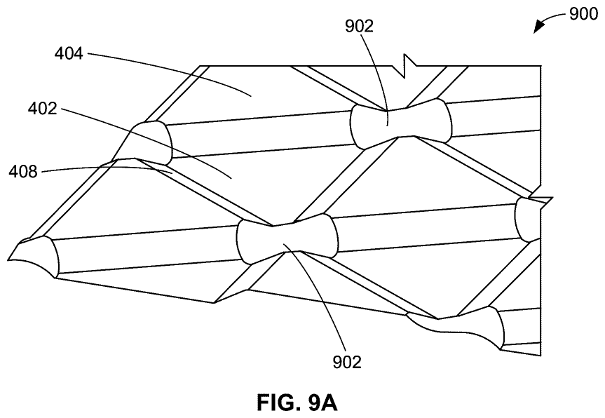

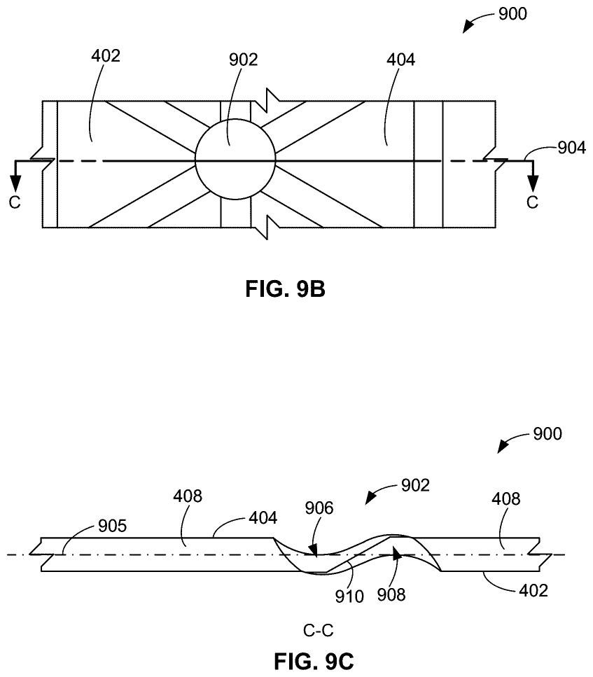

As used herein, the term “unit cell” refers to a fundamental structure or “building block” that repeats in regular intervals to form a solid structure. Unit cells typically are the same size and same shape, but can vary in size and/or shape in the surface they define. A surface of unit cells with varying shapes and different shapes is explained in more detail with respect to FIG. 9B and FIG. 9C.

As used herein, the term “grid” or “array” means a solid surface composed of solid repeating unit cells. This two dimensional grid or array can also be called a “lattice” which is defined as a solid surface, rather than as a collection of nodes or points forming empty holes or openings in a variety of shapes.

As used herein, the term “laterally adjacent” means to share a common edge or neighbor. For example, the squares on a chess board are laterally adjacent as the black and white squares form a two-dimensional 8 by 8 grid, with many squares sharing common edges. Laterally adjacent objects do not have to be in the same vertical plane. Laterally adjacent objects can be connected and offset (e.g., above and below) a neutral plane that defines a center line through the structure.

An example surface can be created from a first plurality or set of unit cells laterally adjacent to and interconnected with a second plurality or set of unit cells, where cells in the first plurality of unit cells are offset from a neutral plane in a first radial direction and cells in the second plurality of unit cells are offset from the neutral plane in a second radial direction. The interconnected first and second pluralities of unit cells define a solid surface that alternates in offset with respect to the neutral plane, wherein the structure is a stiffened structure (e.g., formed of or including a stiffening pattern, etc.).

Some cylindrical structures are formed from a grid of unit cells at uniform radial locations (e.g., in-line unit cells) accompanied with ribs extending radially outward from the structures at the edges of the unit cells to increase stiffness (e.g., conventional isogrids). However, because the ribs of cylindrical structures with conventional isogrids are transversely unsupported structures (e.g., radially extending structures) of low volume, it can be difficult to form the cylindrical structures using additive manufacturing techniques. In the event that the cylindrical structures with conventional isogrids are formed using additive manufacturing techniques, extensive post-processing machining is often necessary. Further, the ribs of the cylindrical structures including conventional isogrids can extend as far as 0.5 inches or more radially outward from one or more cylindrical faces of the cylindrical structures, causing adverse aerodynamic interruptions.

Example stiffening patterns (also referred to as stiffening structures or stiffened structures) increase the stiffness of isogrid structures such as those included in turbofan structures and/or components such as the bypass duct, the fan casing, the compressor casing, liner(s), the nacelle, and/or the engine cowls, etc., by implementing two opposing surfaces (or surface subsets) of unit cells connected at nodes (e.g., forming a stiffening pattern). The opposing surfaces of the isogrid structures disclosed herein cause an increased moment of inertia relative to conventional isogrids. For example, the increased moment of inertia is computationally determined due to the geometry of the stiffening patterns. The increased moment of inertia improves the isotropic stiffness of the structure. Example structures are formed with stiffening patterns including pairs of alternating recessed (e.g., inboard with respect to a neutral plane or axis) and protruding (e.g., outboard with respect to the neutral plane or axis) trigonal unit cells laterally adjacent and integral with one another. Alternatively or additionally, example structures are formed with stiffening patterns including alternating recessed (e.g., inboard) and protruding (e.g., outboard) trigonal unit cells laterally adjacent and integral with one another that increase in size along the surface. Example structures additionally or alternatively include square unit cells, rectangular unit cells, hexagonal unit cells, etc. For example, the moment of inertia (e.g., the second moment of area) is increased due to the alternating recessed and protruding unit cell local centers of mass and/or centers of cross sectional area, reducing bending in the panel due to applied forces and/or moments. For example, the location of a cross sectional centroid, a neutral plane, and/or other neutral reference of a structure including stiffening patterns disclosed herein is between the recessed and protruding unit cells, increasing the moment of inertia and strength and reducing bending. The protruding unit cells are offset in the radial, or normal, direction from the recessed unit cells (surrounding the neutral plane of bending), for example. Example structures include varying shape and density for local increased bending stiffness to accommodate concentrated loads, such as the loads introduced by the inertial loads of accessories mounted on ducts of aircraft engines. Structures formed with stiffening patterns disclosed herein can be readily machined using additive manufacturing techniques such as powder bed fusion (PBF), electron beam melting (EBM), selective laser sintering (SLS), Cold Spray Additive Manufacturing (CSAM), superplastic forming, hog out and mill, nonconventional chemical milling, direct metal laser sintering (DMLS), etc.) and/or subtractive manufacturing tools and techniques (e.g., computer numerical control (CNC) milling, Electrochemical Machining (ECM), etc.) Additionally or alternatively, structures formed with stiffening patterns can be machined from wrought material with machining tools and/or with chemical machining processes, can be cast, etc.

Further, example stiffening patterns allow for a lower total height and/or thickness when compared to structures including conventional isogrids with protruding ribs. Accordingly, stiffening patterns can be implemented in connection with aircraft components exposed to air flow without creating as much aerodynamic disturbance as the conventional isogrids. As described above, material such as cylindrical structures including stiffening patterns can be used to implement portions of a high-bypass and/or low-bypass gas turbine engine.

Certain examples enable manufacture of isogrid/isopanel structures and/or other structures in a single piece with improved performance, reliability, weight, and integrity. In certain examples, a part, such as a cylinder, a conical shape, a multi-cross section transition duct, or any shape with an axisymmetric surface of revolution (e.g., a surface that is symmetrical around an axis of revolution), etc., can be used. A tool, such as a low plasticity burnishing tool (LPB), a friction stir welding (also referred to as stir friction welding) tool, other tool capable of impact-controlled plastic deformation to the part formed, is placed on the inner diameter of the part. A support structure is placed on the outer diameter of the part in approximately the same position as the tool. Alternatively, the tool can be placed against the outer diameter of the part (e.g., outside the part), and the support structure can be placed against the inner diameter of the part (e.g., inside the part), as long as the tool and support structure are aligned such that the support structure provides resistance when the tool impacts the part. The tool and the support structure can be connected to each other in a “c-clamp” style arrangement, for example. The part is supported on top and bottom with a frame (e.g., a stiff or stiffening frame, etc.) that provides a tension/strain condition on the part to allow deformation and/or other action from the tool to occur. The frame can be adapted for a shape of each part or category/type of part to provide appropriate hoop and axial stress on the part. Collectively, the elements can be referred to as deformation equipment, for example.

While some techniques involve one or multiple robot arms to manipulate a part, certain examples mount the deformation equipment on a stage, such as 3 or 5 axis stage, and the part can be positioned on a turntable. Using this configuration enables substantially faster manufacturing that use of casting or traditional machining. Further, no molds or custom fixtures are required for each different part. Certain examples provide a framework for design flexibility that enables novel stiffening patterns to be made at the same cost as more traditional patterns. Certain examples provide formation of isogrids and other parts with less weight and the same or greater stiffness than parts made with chem-milling or traditional machining, for example. Certain examples enable manufacture and formation of novel organic stiffening patterns that are difficult or impossible to manufacture traditionally. Certain examples save weight and improve buy-to-fly ratio for structures, such as Ti64, Ti6242, Ti17, etc., structures.

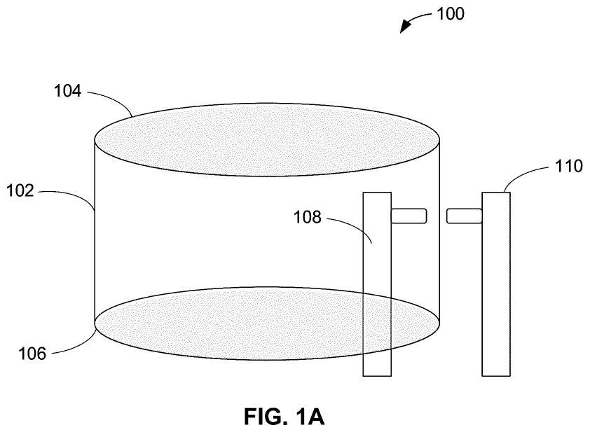

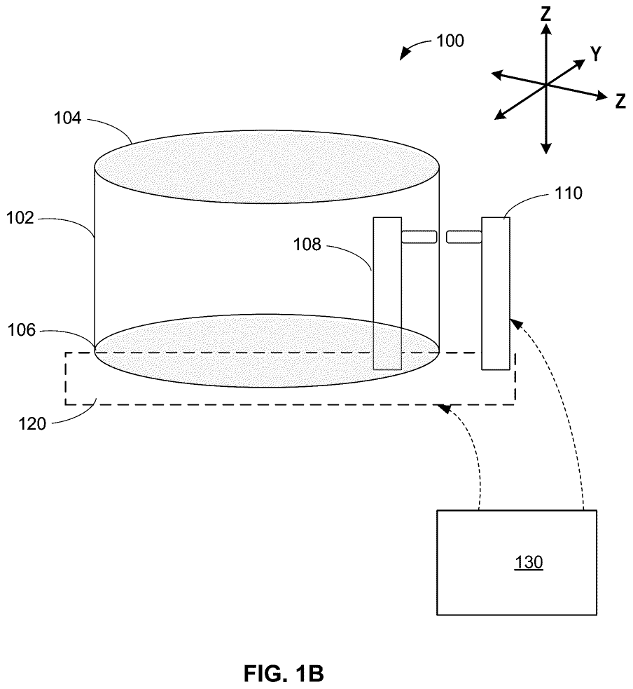

FIGS. 1A-1B illustrates an example apparatus 100 for formation of a part 102. As shown in FIG. 1A, the example apparatus 100 includes an upper frame 104 and a lower frame 106 to position and support the part 102. The example apparatus 100 further includes a tool 108, such as a low plasticity burnishing tool (LPB), a friction stir welding (FSW) tool, other tool capable of impact-controlled plastic deformation to the part, etc. The example apparatus 100 also includes a support structure 110. The example support structure 110 is positioned on an outside surface of the part 102 opposite the tool 108, which is positioned on an inside surface of the part 102. Alternatively, the tool 108 can be placed against an outside diameter of the part 102, and the support structure 110 can be positioned against an inside diameter of the part 102, in opposition to the tool 108. As such, the support structure 110 provides resistance to the impact and/or other motion of the tool 108 against the surface of the part 102 to form a pattern of deformation in the part 102.

In certain examples, the support structure 110 can move with the tool 108 with respect to the part 102 to perform an operation, such as burnishing, deformation, etc., on the part 102. For example, the tool 108 and support structure 110 move in tandem (e.g., via robot arm, manually, etc.) across different areas of the part 102 to form a pattern of deformations in the part 102. Alternatively or additionally, the part 102 in the frame 104, 106 is moved with respect to the tool 208 and support structure 110 (e.g., by rotating the part 102, by moving the part 102 in the x/y direction, etc.). In certain examples, a processor (not shown in this view), such as the example processor platform 1100, can be programmed to control movement and manufacture of a certain pattern in the part 102 (e.g., by controlling movement of the tool 108 and support structure 110, by controlling movement of the part 102, etc.).

In certain examples, the tool 108 is an LPB tool, which is made of hardened metal (e.g., hardened steel, etc.) with a smooth, rounded surface to apply pressure to the surface of the part 102. The LPB tool 108 improves the usable life and damage resistance of the part 102 by pressing a spherical ball at the end of the LPB tool 108 against the surface of the part 102 to deform the surface and create a compressive residual stress in the surface of the part 102. Done repeatedly across the part 102, a stiffening pattern is formed in the surface of the part 102.

Alternatively or additionally, the tool 108 is a FSW tool, which rotates with respect to the surface of the part 102 to generate heat to melt and intermix a second metal with the first metal of the surface of the part 102. The FSW tool 108 can then create a stiffening pattern in/on the surface of the part 102.

FIG. 1B shows the example formation apparatus 100 further including a table 120, such as a turntable, a multi-axis stage (e.g., a three-axis stage, five-axis stage, etc.), etc. The table 120 allows the part 102 to rotate and/or otherwise move with respect to x, y, z and/or other defined axes (e.g., tilt, pitch, etc.), for example. The example apparatus 100 shown in FIG. 1B also includes a controller 130 to adjust position of the tool 108, the support structure 110, and/or the table 120. The controller 130 can store a stiffening pattern in memory and execute instructions with at least one processor included in the controller 130 to form the stiffening pattern on/in the part 102.

In certain examples, stiffening patterns (also referred to as stiffening structures or stiffened structure) can be formed in the part 102 to implemented in connection with structures of a turbofan and/or other engine having, for example, cylindrical or annular properties. A fan casing, a bypass duct (e.g., an exterior, interior, or entirety of the bypass duct), and/or cowls of the nacelle can include the stiffening patterns disclosed herein. One or more casings of the outer casing, such as a compressor casing, can also include the stiffening patterns disclosed herein. Further, though the stiffening patterns are discussed in connection with the high-bypass-type turbofan, stiffening patterns disclosed herein can also be implemented in connection with low-bypass-type turbofans. For instance, a dedicated bypass duct can extend from a fan casing at the fore of a low-bypass-type turbofan towards the aft of the low-bypass-type turbofan and can include stiffening patterns disclosed herein. Further, an exhaust/afterburning section casing, a fan casing, a compressor casing, a cowl, and/or a nacelle, etc., of the low-bypass-type turbofan can also include the stiffening patterns disclosed herein. The stiffening patterns can also be used to form a liner for a turbine engine. The stiffening pattern formed in the structure provides resistance to buckling such as due to compressive pressure loading and/or other inward loading.

More specifically, under compressive loading, a structure can be deformed by buckling and/or bending due to the differential pressure (delta P). Certain examples provide a structure forming a surface that can help resist such buckling and/or bending effects caused by compressive loading (e.g., experienced by a turbine engine in operation, etc.). In some turbine engines, the combustion chambers are high compression systems in which high pressure air and fuel are mixed and burned at a constant pressure. The combustion chamber is lined with a combustor or engine liner, which is subjected to a high delta P in operation. Certain examples provide a stiffening structure that can be used to form a pressure-resistant combustor liner to resist buckling and/or bending effects. Other turbine engine parts can be formed of such structure to resist buckling and/or bending due to delta P (e.g., inward) loading and/or other compressive pressure, for example.

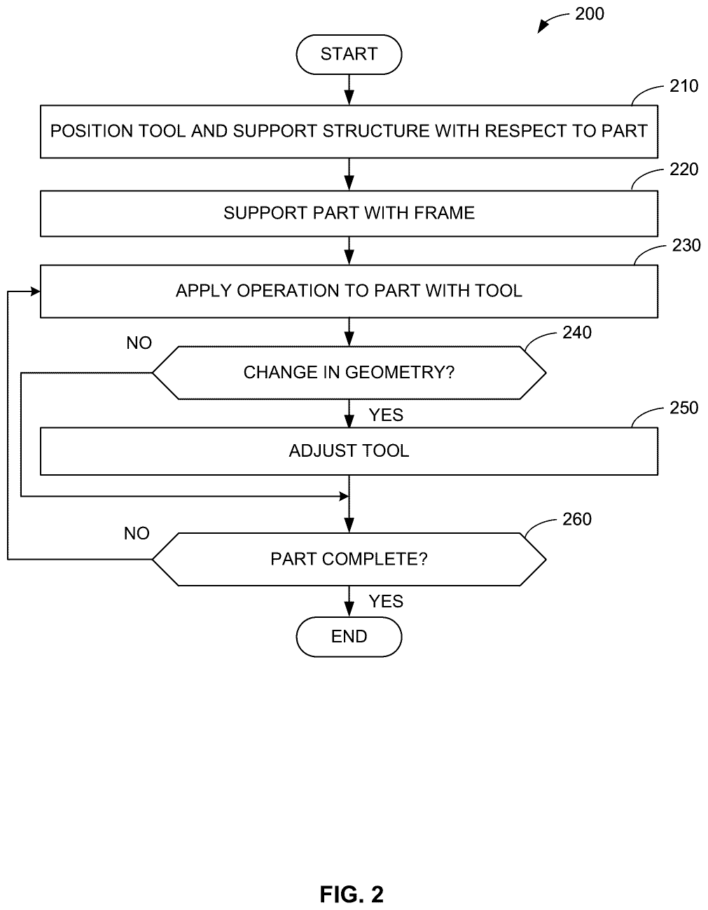

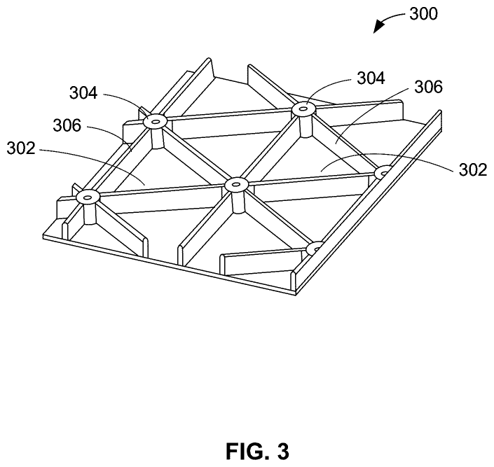

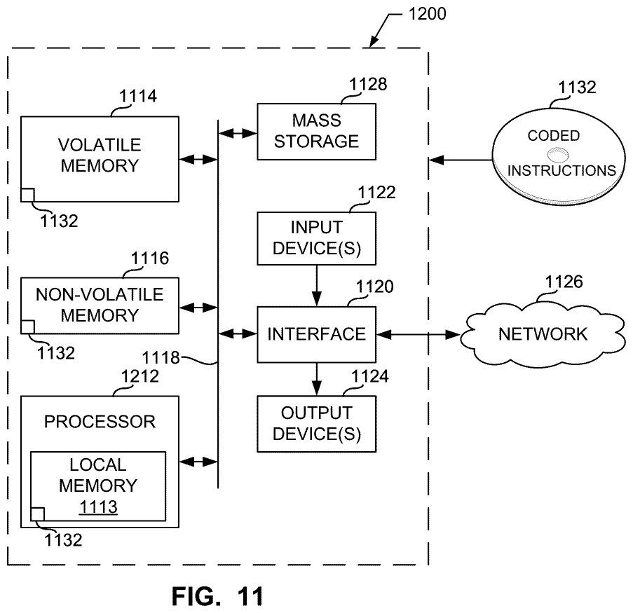

A flowchart representative of example hardware logic, machine readable instructions, hardware implemented state machines, and/or any combination thereof is shown in FIG. 2. The machine readable instructions may be one or more executable programs or portion(s) of an executable program for execution by a computer processor such as the processor 1112 shown in the example processor platform 1100 discussed below in connection with FIG. 11. The processor platform 1100 can be used to implement the controller 130 of the example of FIG. 1B. The apparatus of FIGS. 1A-1B can form a stiffening pattern in the part 102 using the example process 200 shown in FIG. 2. The computer processor 1100 is used to drive an apparatus, such as the example apparatus 100, to execute the process 200 to manufacture one or more aircraft components and/or engine components. The program may be embodied in software stored on a non-transitory computer readable storage medium such as a CD-ROM, a floppy disk, a hard drive, a DVD, a Blu-ray disk, or a memory associated with the processor 1112, but the entire program and/or parts thereof could alternatively be executed by a device other than the processor 1112 and/or embodied in firmware or dedicated hardware. Further, although the example program is described with reference to the flowchart illustrated in FIG. 2, many other methods of implementing the example manufacturing process to form an example aircraft component (e.g., a structure) including the stiffening pattern for unit cell structures of FIGS. 3-8 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIG. 2 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

FIG. 2 illustrates a flow diagram of an example method 200. At block 210, the tool 108 and the support structure 110 are positioned with respect to the part 102. For example, the tool 108, such as an LPB tool, an FSW tool, or another tool capable impart controlled plastic deformation to the part, is placed on an inside of the part 102. The support structure 110 is positioned near the same location as the tool 108 but on an outside of the part 102. The tool 108 and the support structure 110 can be connected, such as using a clamp, etc.

At block 220, the part 102 is supported on top and bottom with a frame 104, 106. The stiff frame 104, 106 can apply a tension/strain condition on the part 102 to enable the burnishing and/or deformation by the tool 108, for example. The frame 104, 106 can be adapted based on a shape of the part 102 to provide appropriate hoop and axial stress on the part 102, for example. The deformation equipment 104, 106 can be mounted on a stage 120, such as a 3-axis stage, 5-axis stage, etc., and the part 102 can be mounted on a turntable 120, for example.

At block 230, an operation, such as burnishing, deformation, etc., is applied to the part 102 by the tool 108. For example, formation of stiffening patterns in a metal part can be conducted to form isopanel cases, ducts, etc. Full revolution parts 102 can be formed by plastic deformation of sheet metal in the frame 104, 106 using the tooling 108 to locally deform the part 102, for example. When the part 102 is mounted in the support frame 104, 106 on a table 120, for example, the frame 104, 106 can move (e.g., in both x and y planes, z plane, tilt, etc.), and the cylinder of material moves with the frame. The tool 108 is applied to the material between the tool 108 and the support structure 110 to deform/burnish the material and form the isopanel in the part 102.

In certain examples, a computer and/or other processor 130 can be connected to a motor moving the frame 104, 160 and/or the table 120, and/or controlling the tool 108. A desired geometry for the part 102 can be programmed to control the tool 108, for example. If, at block 240, a change in geometry is desired, then, at block 250, the tool 108 can be adjusted. For example, a size of triangles formed in the metal to generate an isopanel can be adjusted. The tool 108 can be reprogrammed to change part pattern/geometry dynamically (“on the fly”), for example, to form smaller or larger triangles and/or other shapes to improve stiffening at one or more particular locations, for example. The change in geometry can be specified in instructions, a model, and/or a file identifying the desired stiffening pattern for the part 102, for example. At block 260, tool 108 operation continues until the part 102 is formed. For example, the stiffening pattern is replicated across a desired area of the part 102 such as all of the surface of the part 102, an area of the part 102 specified by the stiffening pattern configuration, etc.

FIG. 3 is a perspective view of an example isogrid structure 300 (e.g., a conventional isogrid 300, etc.). The isogrid structure 300 includes conventional unit cells 302, each defined between three conventional nodes 304 and three conventional ribs 306. Though only a portion of the conventional unit cells 302, the conventional nodes 304, and the conventional ribs 306 are labeled in FIG. 3, the unlabeled portions of the isogrid structure 300 also include the described arrangement of the conventional unit cells 302, the conventional nodes 304, and the conventional ribs 306. Conventional isogrids, such as the conventional isogrid structure 300, are load bearing structures characterized by nodes 304 and/or the ribs 306 adhered to a plate, each pair of nodes, ribs and plate portion defining a unit cell 302. As used herein, a “node” adjoins two or more unit cells at a corner of each unit cell. For example, a unit cell can be square, rectangular, or trigonal, etc. Cylindrical structures formed in the manner of the known conventional isogrid structure 300 include the conventional unit cells 302 at uniform radial locations (e.g., in-line unit cells), with the conventional nodes and ribs 304, 306 extending radially outward and/or inward from the structures at the edges of the conventional unit cells 302. However, because the conventional nodes and ribs 304, 306 are transversely unsupported structures (e.g., radially extending structures) of low volume, it can be difficult to form the cylindrical structures using additive manufacturing techniques. In the event that the cylindrical structures are formed using additive manufacturing techniques, extensive post-processing machining is often necessary. Further, the conventional ribs 306 of the cylindrical structures including conventional isogrids can extend as far as 0.5 inches or more radially outward from one or more cylindrical faces of the cylindrical structures, causing adverse aerodynamic interruptions. The example apparatus 100 can instead be used to form the isogrid pattern 300 in the part 102 using the tool 108 and support structure 110, for example.

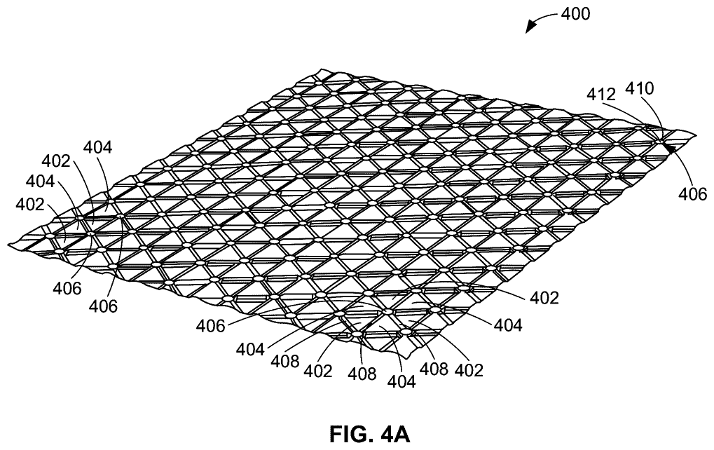

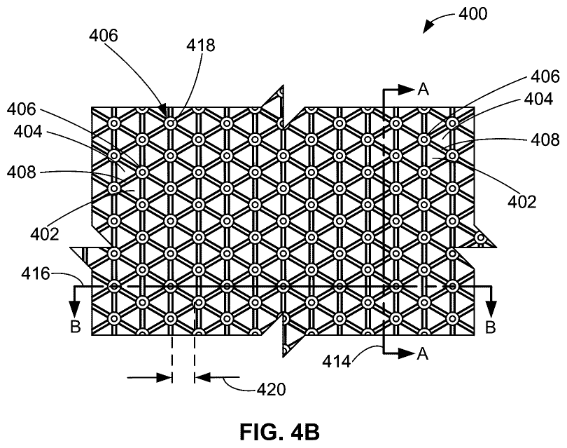

FIG. 4A is a perspective view of an example first panel 400 including an example stiffening pattern for unit cell structures that can be implemented in connection with the teachings of this disclosure. In some examples, the stiffening pattern for unit cell structures of the first panel 400 can be implemented in connection with at least a portion of a cylindrical structure or a frustoconical structure. In FIG. 4A, the first panel 400 includes recessed unit cells 402 and protruding unit cells 404 (e.g., relative to the conventional unit cells 302 of the conventional unit cell structure 300 and/or a neutral plane of the first panel 400) surrounding nodes 406 formed by the tool 108 in the part 102. In FIG. 4A, the recessed unit cells 402 and the protruding unit cells 404 are equilateral triangles (e.g., trigonal) formed by applying the tool 108 to the part 102 in a repeating pattern. Each recessed unit cell 402 is joined to three of the protruding unit cells 404 at respective transition edges 408. Similarly, each protruding unit cell 404 is joined to three of the recessed unit cells 402 at respective ones of the transition edges 408. Each of the recessed unit cells 402 and the protruding unit cells 404 is joined to three of the nodes 406 and is joined to one of the nodes 406 at each corner of the unit cell, like the arrangement of the conventional unit cell 302. Three of the recessed unit cells 402 and three of the protruding unit cells 404 are joined to a node 406. However, unlike conventional nodes 204, the nodes 406 are adjoined to the recessed and protruding unit cells 402, 404 at opposing ends of the nodes 406. Though only a portion of the recessed unit cells 402, the protruding unit cells 404, the nodes 406, and the transition edges 408 are labeled in examples provided herein, the unlabeled portions of the first panel 400 and other structures implementing the stiffening patterns disclosed herein also include the described arrangement of the recessed unit cells 402, protruding unit cells 404, transition edges 408, and nodes 406. The recessed unit cells 402 collectively define a first plurality or set of unit cells (e.g., a first plurality of trigonal unit cells, etc.). The recessed first plurality of unit cells 402 are offset from the neutral plane in a first radial direction and are interconnected by nodes. The protruding unit cells 404 collectively define a second plurality or set of unit cells (e.g., a second plurality of trigonal unit cells, etc.). The protruding second plurality of unit cells 404 are offset from the neutral plane in a second radial direction and are interconnected by nodes. While trigonal unit cells are provided as an example, the first and/or second plurality of unit cells can include rectangular and/or square unit cells in a waffle grid arrangement, cells of differing sizes, cells of differing shapes, etc.

In FIG. 4A, the alternating arrangement of the recessed unit cells 402 and the protruding unit cells 404 creates opposing surfaces (e.g., surfaces displaced from one another) by aligning the recessed unit cells 402 opposed from the protruding unit cells 404. A first surface is defined by the recessed unit cells 402, and a second surface is defined by the protruding unit cells 404. The nodes 406 join the first surface to the second surface (e.g., collectively, the opposing surfaces) by joining alternating ones of the recessed unit cells 402 and the protruding unit cells 404 to one another. The first surface is displaced (e.g., offset) a distance on the radial axis R from the second surface in a normal (e.g., 90 degrees, perpendicular, orthogonal) direction, increasing the moment of inertia of the first panel 400 and increasing the resistance of the first panel 400 to bending such as out-of-plane bending or buckling. Ones of the recessed unit cells 402 alternate with ones of the protruding unit cells 404 such that the cells are laterally adjacent forming a grid arrangement. In the example of FIG. 4A, the first direction is normal or orthogonal to the first surface. Further, because each unit cell of the recessed and protruding unit cells 402, 404 is an equilateral triangle (e.g., trigonal), the first panel 400 has increased resistance to bending regardless of the axis on the panel 400 about which the panel 400 is bent and/or has isotropic macroscopic properties. In other examples, each unit cell of the recessed and protruding unit cells 402, 404 are square unit cells and have orthotropic macroscopic properties (e.g., orthotropic grid structures), forming a waffle grid. In FIG. 4A, the nodes 406 include outer edges 410 surrounding first recesses 412. Though only one of the outer edges 410 and one of the first recess 412 are labeled on one of the nodes 406, each node 406 on the first panel 400 includes an outer edge 410 and a first recess 412. It is important to note that each unit cell does not need to have isotropic macroscopic properties.

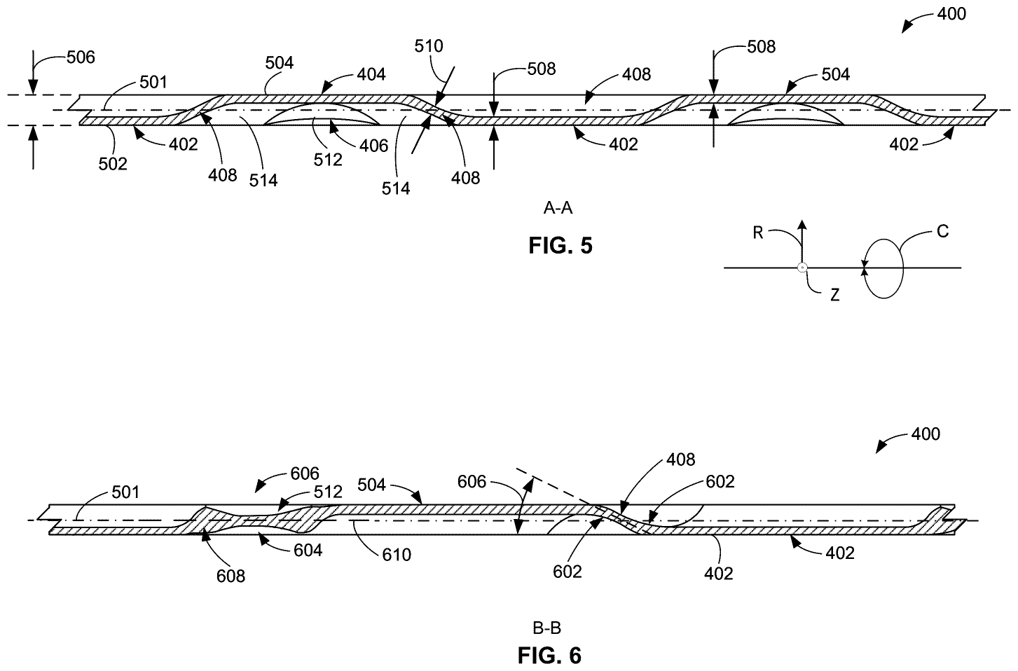

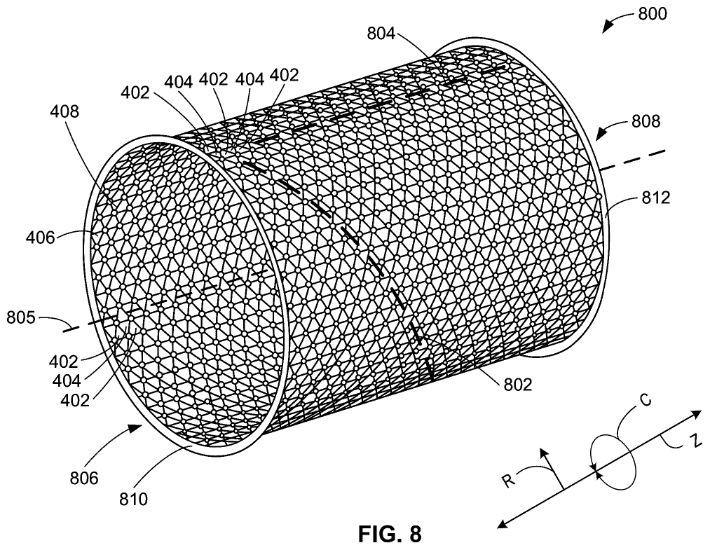

In FIG. 4A, the stiffening pattern created by two offset (e.g., protruding and recessed) pluralities of unit cells 402, 404, joined by nodes stiffens the structure. The stiffened structure (discussed further in connection with FIG. 5) is planar (e.g., non-cylindrical) because the stiffening pattern is disposed on the first panel 400, which does not include an overarching curvature (e.g., an overarching curvature associated with a cylindrical and/or annular structure). In other examples, the opposing surfaces (e.g., the first and second surfaces) defined by the recessed unit cells 402 and the protruding unit cells 404 can be annular surfaces, cylindrical surfaces, etc. An example implementation of the stiffening pattern of the first panel 400 of FIG. 4A is described in greater detail in connection with a cylindrical structure shown in FIG. 8.

FIG. 4B is a front view of the first panel 400 of FIG. 4A showing a cutting line A-A 414 and a cutting line B-B 416. In the view of FIG. 4B, the first panel 400 is broken at each side. Thus, a portion of the recessed unit cells 402, the protruding unit cells 404, the nodes 406, and the transition edges 408 (all of FIG. 4A) of the first panel 400 appear in the view of FIG. 4B. The nodes 406 are shown with first contour lines 418 to illustrate the first recesses 412 (FIG. 4A). A first distance 420 indicates a triangle height of a unit cell of the recessed and protruding unit cells 402, 404. In some examples, the first distance 420 is 2 inches (or approximately 2 inches±0.01 inches, etc.). In some examples, the first distance 420 is between 1 inch and 4 inches.

FIG. 5 is an enlarged view of a cross-section of the first panel 400 of FIG. 4A taken along the A-A cutting line 414 of FIG. 4B. In the view of FIG. 5, the first panel 400 is broken at each side. A portion of the recessed unit cells 402 and the protruding unit cells 404 (both of FIG. 4A) appear in the view of FIG. 5. In FIG. 5, the cut of the A-A cutting line 414 is taken perpendicular to the triangle height of the unit cells 402, 404 indicated by the first distance 420 (FIG. 4B) and the cut of the A-A cutting line 414 is displaced approximately half of the first distance 420 (e.g., triangle height) from edges of alternating ones of the recessed unit cells 402 and the protruding unit cells 304. In FIG. 5, a first dashed-dotted line 501 indicates a neutral plane for bending (e.g., the location measured between second surface 504 and first surface 502 where the in-plane shear stress is zero when subjected to bending about the longitudinal axis Z, where the longitudinal axis Z extends perpendicularly into and/or out of the page in FIG. 5. If the example cross section of the first panel 400 is bent completely about the longitudinal axis Z, then a cylindrical structure is created as the direction around the circumferential axis C will revolve completely around a circle (e.g. Theta is 360), as seen in FIG. 8. However, the example of FIG. 5 is a non-cylindrical sheet with a Theta of 0, not experiencing any bending, with unit cells laterally adjacent along the longitudinal axis (e.g., front and back) and laterally adjacent side to side (e.g., left and right). The unit cells 402, 404 are laterally adjacent and, thus, share a common edge despite being radially offset in the radial direction R. The neutral plane indicated by the dashed-dotted line 501 divides the first panel 400 into a first portion (e.g., a first portion including each of the protruding unit cells 404, relatively higher on the page in the view of FIG. 5) and a second portion (e.g., a second portion including each of the recessed unit cells 402, relatively lower on the page in the view of FIG. 5). The surface or structure of the example panel 400 that is created by the interconnection of the first plurality of unit cells 402 and the second plurality of unit cells 404 formed by the tool 108 and support structure 110 in the part 102 is a continuous, solid surface that alternates between two planes (e.g., the protruding plane and the recessed plane) at an offset distance from the neutral plane. Similarly, the neutral plane indicated by the first dashed-dotted line 501 intersects each of the nodes 406 and the transition edges 408 of the first panel 400. In some examples, stiffening patterns disclosed herein include curvature. In these examples, the neutral plane is not necessarily planar (e.g., straight) throughout, but locally divides the recessed and the protruding unit cells 402, 404.

As such, stiffening patterns can be implemented with respect to a neutral plane to define a variety of structures in a variety of shapes (e.g., curved, flat, angled, etc.). For example, a helical structure can be formed including the stiffening patterns disclosed herein including a corresponding helical neutral plane extending through the helical structure dividing recessed unit cells (e.g., the recessed unit cells 402) from protruding unit cells (e.g., the protruding unit cells 404). As another example, an exterior of an airfoil (e.g., including a leading edge, a trailing edge, and a chord) can be formed including the stiffening patterns disclosed herein including a neutral plane having the curvature and shape of the exterior of the airfoil dividing recessed unit cells (e.g., unit cells closer to the center of the airfoil) from protruding unit cells (e.g., unit cells farther from the center of the airfoil). As yet another example, an ovoid structure can be formed including the stiffening patterns disclosed herein including an ovoid neutral plane separating protruding unit cells from recessed unit cells.

In the orientation of FIG. 5, a first plurality or set or collection 502 is defined by (e.g., aligned with, in the same plane as) the recessed unit cells 402. Similarly, a second plurality or set or collection 504 is defined by (e.g., aligned with, in the same plane as) the protruding unit cells 404. A second distance 506 (e.g., an offset in the R direction) indicating the total thickness of the first panel 400 is defined by the first surface 502 and the second surface 504 (e.g., between the lower face of the recessed unit cells 402 and the upper face of the protruding unit cells 404). In some examples, the second distance 506 is 0.3 inches (or approximately 0.3 inches±0.01 inches, etc.). Stiffening patterns disclosed herein allow for a lower total height and/or thickness (e.g., the second distance 506) when compared to structures including conventional isogrids such as the conventional isogrid structure 300 (FIG. 3).

A third distance 508 of the first panel 400 is a thickness of a recessed unit cell 402 and/or a protruding unit cell 404. In some examples, the third distance 508 is 0.025 inches (or 0.025 inches±0.01 inches, etc.). In some examples, the third distance 508 is between 0.025 inches and 0.5 inches. In some examples, the tolerance of the third distance 508 is between ±0.005 inches and ±0.01 inches.

A fourth distance 510 is a thickness of a transition edge 408 of the first panel 400. The fourth distance 510 can be a web thickness (e.g., a thickness of a connecting portion such as the transition edge 408) of the first panel 400. In some examples, the fourth distance 510 is 0.025 inches (or 0.025 inches±0.01 inches, etc.). In some examples, the fourth distance 510 is between 0.025 inches and 0.05 inches. In some examples, the tolerance of the fourth distance 510 is between ±0.005 inches and ±0.01 inches.

In FIG. 5, underbodies 512 of the nodes 406 are visible. The underbodies 512 are positioned at the intersections of example undersides 514 of transition edges 408. The underbodies 512 are rounded, for example, to allow for the first recesses 412 (FIG. 4A) of the nodes 406. The underbodies 512 and, more generally, the nodes 406 encompass portions of the edges of the unit cells 402, 404 to increase stiffness of the first panel 400. In some examples, a first portion of the unit cells 402, 404 have one or more different dimensions (e.g., different values of the first distance 420, the second distance 506, the third distance 508, and/or the fourth distance 410, etc.) from a second portion of the unit cells 402, 404.

In the view of FIG. 6, the node 306 is shown bisected, revealing a cross section of the first recess 312. In FIG. 6, an underside of the node 306 includes a second recess 604. The inclusion of the first recess 312 and the second recess 604 can reduce the material used for the stiffening pattern of the first panel 300. In FIG. 6, the transition edge 308 extends from the recessed unit cell 302 at a first angle 606 relative to the first surface 402 (FIG. 4). For example, the first angle 606 can be 30°±5° inches. In some examples, the first angle 606 is less than 90° such that the first panel 300 can be formed using an additive manufacturing process.

Visible in the view of FIG. 6 is an annular thickened portion 608 of the node 306. The thickened portion 608 defines the first recess 312 and the second recess 604 of the node 306. Further, the thickened portion 608, the first recess 312, and the second recess 604 of the node 306 demonstrate that the node 306 is substantially symmetrical about an example third dashed line 610. As used herein, “substantially symmetrical” refers to a condition in which the portion of the node 306 below the third dashed line 610 can be rotated 180°±10° to take the shape of the portion of the node 306 above the third dashed line 610. In some examples, the remainder of the first panel 300 displays this symmetry.

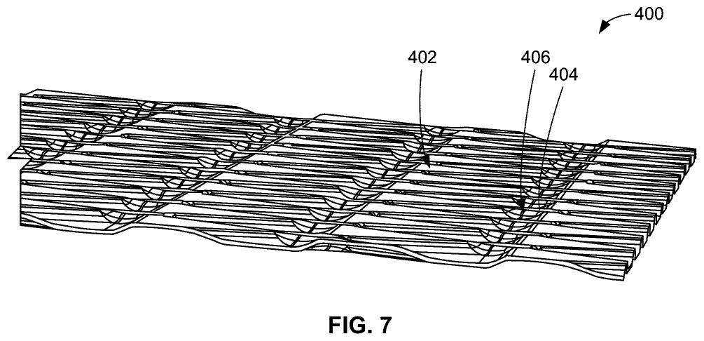

FIG. 7 is another perspective view of the first panel 400 of FIG. 4A showing the reverse side of the first panel 400. The view of FIG. 7 illustrates an underside of the recessed unit cells 402, and further illustrates the symmetry present in the first panel 400. The second recesses 404 of the nodes 406 are also shown in the view of FIG. 7. FIG. 7 is an example “sheet” or non-cylindrical surface, with an angle Theta of zero degrees that is also extended parallel to a neutral plane. FIG. 8 depicts the example sheet of FIG. 7 formed into a cylinder by bending the sheet about the longitudinal axis Z for an angle Theta of 360 degrees.

FIG. 8 is a perspective view of an example cylindrical structure 800 that can be implemented including the stiffening pattern for unit cell structures of FIGS. 4A-B (e.g., the stiffening pattern of the first panel 400). Alternatively, the cylindrical structure 800 can be a frustoconical structure (e.g., a cylinder with an opening at one end of a specific radius, and the opening at the other end with a differently sized radius). In FIG. 8, the cylindrical structure 800 is discussed in connection with the directional conventions of an example turbofan. For example, a central axis of the cylindrical structure is coincident with the longitudinal and centerline axis of the turbofan. In some examples, the cylindrical structure 800 includes all of the aspects of the first panel 400 of FIGS. 4A-6 with geometrical variation to account for the curvature of the cylindrical structure 800. In some examples, the cylindrical structure is a unitary structure (e.g., monolithic, integral, etc.) composed of continuous material formed in the part 102 by the tool 108 and the support structure 110 described in connection with FIGS. 1A-2.

When implemented in connection with the cylindrical structure 800, the alternating ones of the recessed unit cells 402 and the protruding unit cells 404 form a spiral about the cylindrical structure 800 indicated partially by an example fourth dashed line 802 tracing one such spiral. An example fifth dashed line 804 indicates a linear arrangement of alternating ones of the recessed unit cells 402 and the protruding unit cells 404 parallel with the centerline axis. Along both the fourth dashed line 802 and the fifth dashed line 804, the recessed unit cells 402 can be inboard unit cells 402 and the protruding unit cells 404 can be outboard unit cells 404. The inboard unit cells 402 are disposed closer to the centerline axis 805 of the cylindrical structure 800 than the outboard unit cells 404.

In other examples, alternating recessed unit cells 402 and protruding unit cells 404 can be formed by the tool 108 in the part 102 such that the cells are arranged in a ring about the central axis (e.g., longitudinal axis Z) of the cylindrical structure 800 (e.g., a portion of the transition edges 408 are arranged along the circumference of the cylindrical structure 800). The cylindrical structure 800 can be representative of a cylindrical and/or annular structure such as a fan casing, a bypass duct, and/or cowls of a nacelle and/or components of a low-bypass-type turbofan, etc. Accordingly, the geometry of the component, such as the fan casing, bypass duct, and/or cowl of the nacelle, etc., can include one more contours, edges, protrusions, cavities, bores, etc. (e.g., geometric features), that vary from the shape of the cylindrical structure 800. The arrangement of the stiffening pattern shown in connection with the cylindrical structure 800 can be modified to account for any of these geometric features.

In FIG. 8, the opposing surfaces formed by the recessed unit cells 402 and the protruding unit cells 404 are cylindrical surfaces. A first cylindrical surface is defined by the recessed unit cells 402, and a second cylindrical surface is defined by the protruding unit cells 404, the recessed unit cells 402 and the protruding unit cells 404 together forming the cylindrical structure 800. Locally, the arrangement of the recessed unit cells 402 relative to the protruding unit cells 404 retains a high moment of inertia and isotropic properties. Thus, the arrangement of the cylindrical structure 800 resists bending moments, compressive forces, and torsion. In FIG. 8, the cylindrical structure will have a varying neutral plane throughout defining a cylindrical shell separating each of the recessed unit cells 402 from each of the protruding unit cells 404. To form a cylindrical structure, such as the cylindrical structure 800, the recessed and/or protruding unit cells 402, 404 are curved (e.g., bend) for an angle Theta of 360 degrees to form the curvature of the cylindrical structure 800. Additionally or alternatively, to form the cylindrical structure, such as the cylindrical structure 800, laterally adjacent ones of the recessed unit cells 402 and/or the protruding unit cells 404, are formed at angles relative to one another. It is important to note that the local arrangement of recessed unit cells 402 relative to the protruding unit cells 404 does not need to be isotropic.

In FIG. 8, the structure 800 is formed by the tool 108 in pairs of alternating cells laterally adjacent each other in different directions from the neutral plane. Each pair is formed in the part 102 from a recessed unit cells 402 in alternating arrangement with a protruding unit cell 404 such that the pair of cells 402, 404 is laterally adjacent. The recessed unit cells 402 are offset from the protruding unit cells 404 in a third direction normal to the surface defined by the plurality of unit cells. In the example of FIG. 8, the third direction is a radial direction, such that the protruding unit cells 404 are radially farther from the centerline axis than the recessed unit cells 402. The pairs of recessed unit cells 402 and protruding unit cells 404 form a solid continuous surface that alternates around the neutral plane between the protruding plane and the recessed plane.

In FIG. 8, ones of the recessed unit cells 402 alternate with ones of the protruding unit cells 404 in both of a first and second direction orthogonal to each other. The recessed unit cells 402 are offset from the protruding unit cells 404 in a third direction normal to the first and second directions. In FIG. 8, the first direction is the longitudinal axis Z or centerline axis 805, the second direction is the circumferential direction C, and the third direction is the radial direction R, the protruding unit cells 404 radially farther from a centerline axis 805 than the recessed unit cells 402.

The cylindrical structure 800 includes a first end 806 and a second end 808. The first end 806 includes a first flange 810 extending radially outward therefrom, and the second end 808 includes a second flange 812 extending radially outward therefrom.

The cylindrical structure 800 and analogous aircraft components, such as the fan casing, bypass duct, and/or cowl, etc., can be formed using an additive manufacturing process from, for example, the first end 806 to the second end 808. For example, the cylindrical structure 800 and analogous aircraft components can be formed using additive manufacturing tools and techniques such as PBF, EBM, CSAM, SLS, DMLS, etc., and/or subtractive manufacturing tools and techniques such as CNC milling, ECM, etc., can be used to form the cylindrical structure 800.

Examples disclosed herein can form a structure (e.g., the cylindrical structure 800 and/or analogous aircraft components) including a first plurality of unit cells (e.g., the recessed unit cells 402) forming a first surface (e.g., the first surface 502 of FIG. 5), a second plurality of unit cells (e.g., the protruding unit cells 404) forming a second surface (e.g., the second surface 504 of FIG. 6), the first and second surfaces opposed to create a high moment of inertia, and a plurality of nodes (e.g., the nodes 406) joining the first surface and the second surface to form a stiffening pattern. The structure can be a cylindrical structure (e.g., the cylindrical structure 800) defining a central axis and a radial direction, the second surface (e.g., the second surface defined by the protruding unit cells 404 of the cylindrical structure 800) radially farther from the central axis than the first surface (e.g., the first surface defined by the recessed unit cells 402 of the cylindrical structure 800). The structure (e.g., the cylindrical structure 800) can form at least a portion of a duct of a turbofan. At least one unit cell of the first plurality of unit cells (e.g., the recessed unit cells 402) or the second plurality of unit cells (e.g., the protruding unit cells 404) of the structure can be trigonal. The structure can include transition edges (e.g., transition edges 408) further joining the first plurality of unit cells (e.g., the recessed unit cells 402), the second plurality of unit cells (e.g., the protruding unit cells 404), and the plurality of nodes (e.g., the nodes 406). At least one node of the plurality of nodes (e.g., the nodes 406) can include a recess (e.g., the first recess 412 and/or the second recess 604). The first plurality of unit cells (e.g., the recessed unit cells 402) can form a first isogrid and the second plurality of unit cells (e.g., the protruding unit cells 404) can form a second isogrid.

Examples disclosed herein can form a cylindrical structure (e.g., a duct of the turbofan represented by the cylindrical structure 800) surrounding a gas turbine (e.g., the core turbine engine) defining a radial direction R and longitudinal direction Z, the cylindrical structure including a first plurality of unit cells (e.g., the recessed unit cells 402) defining a first portion of a surface (e.g., the first surface defined by the recessed unit cells 402 of the cylindrical structure 800), a second plurality of unit cells (e.g., the protruding unit cells 404) defining a second portion of the surface (e.g., the first surface defined by the protruding unit cells 404 of the cylindrical structure 800), the first plurality of cells interconnected with the second plurality of cells in pairs formed of a cell from the first plurality of cells radially adjacent a cell from the second plurality of cells, the cells of the first plurality of cells radially displaced from the cells of the second plurality of cells relative to a central axis (e.g., longitudinal axis) of the cylindrical structure to create a high moment of inertia, and a plurality of nodes (e.g., the nodes 406) joining cells from the first plurality of unit cells with cells from the second plurality of unit cells.

The cylindrical structure can include a plurality of transition edges (e.g., the transition edges 408) to further join the first plurality of unit cells and the second plurality of unit cells. The first plurality of unit cells can be a first plurality of trigonal unit cells and the second plurality of unit cells can be a second plurality of trigonal unit cells. A transition edge of the transition edges can interface with a first edge of a first unit cell of the first plurality of unit cells (e.g., an edge of a recessed unit cell 402), a second edge of a second unit cell of the second unit cells (e.g., an edge of a protruding unit cell 404 adjacent to the recessed unit cell 402), and a node of the plurality of nodes (e.g., the node 406). The cylindrical structure can be associated with an exterior of a duct of a turbofan, for example. Locations of the plurality of nodes can be equidistant. At least one node of the plurality of nodes can include a recess (e.g., the first recess 412 and/or the second recess 604).

FIG. 9A is a perspective enlarged view of an example second panel 900 formed by the tool 108 and support structure 110 in the part 102 including alternate nodes 902 for use in the stiffening patterns for unit cell structures of FIGS. 4A-8. In FIG. 9A, the alternate nodes 902 are blended nodes to decrease material usage and to increase strength. In FIG. 9A, the second panel 900 includes all of the aspects of the first panel 400, save for the nodes 406 (both of FIG. 4A). Though only a portion of the recessed unit cells 402, the protruding unit cells 404, the alternate nodes 902, and the transition edges 408 are labeled in FIG. 9A, the unlabeled portions of the second panel 900 also include the described arrangement of the recessed unit cells 402, protruding unit cells 404, transition edges 408, and alternate nodes 902.

FIG. 9B is a front view of the second panel 900 of FIG. 9A showing a cutting line C-C 904. As shown in FIG. 9B, the cutting line C-C 904 bisects the alternate node 902 (e.g., the blended node). A recessed unit cell 402 and a protruding unit cell 404 are visible in the view of FIG. 9B.

FIG. 9C is a cross-section of the second panel 900 of FIG. 9A taken along the cutting line C-C 904 of FIG. 9B. In FIG. 9C, the second panel 900 includes a thin thickness (e.g., a low value of the third and fourth distances 508, 510 of FIG. 5). Both the top side and the underside of the second panel 900 are visible in the view of FIG. 9C. The transition edge 308 proximate the protruding unit cell 404 is visible in the view of FIG. 9C on the top side of the second panel 900. The transition edge 408 proximate the recessed unit cell 402 is visible in the view of FIG. 9C on the underside of the second panel 900. In FIG. 9C, a second dashed-dotted line 905 indicates a neutral plane (e.g., a neutral reference) of the second panel 900. The neutral plane indicated by the second dashed-dotted line 905 is located between the recessed unit cells 402 and the protruding unit cells 404. The neutral plane indicated by the second dashed-dotted line 905 divides the first panel 400 into a first portion (e.g., a first portion including each of the protruding unit cells 404, relatively higher on the page in the view of FIG. 9C) and a second portion (e.g., a second portion including each of the recessed unit cells 402, relatively lower on the page in the view of FIG. 9C). Similarly, the neutral plane indicated by the second dashed-dotted line 905 intersects each of the transition edges 408 of the second panel 900. The alternate node 902 includes a first blended region 906 (e.g., a recess, a well, etc.), shown in FIG. 9C on the top side of the second panel 900. The alternate node 902 includes a second blended region 908 (e.g., a recess, a well, etc.), shown in FIG. 9C on the underside of the second panel 900. In FIG. 9C, the first blended region 906 appears concave up and the second blended region 908 appears concave down. In the example of FIG. 9C, the second blended region 908 can be viewed as a 180° reflection of the first blended region 906 about a node transition 910.

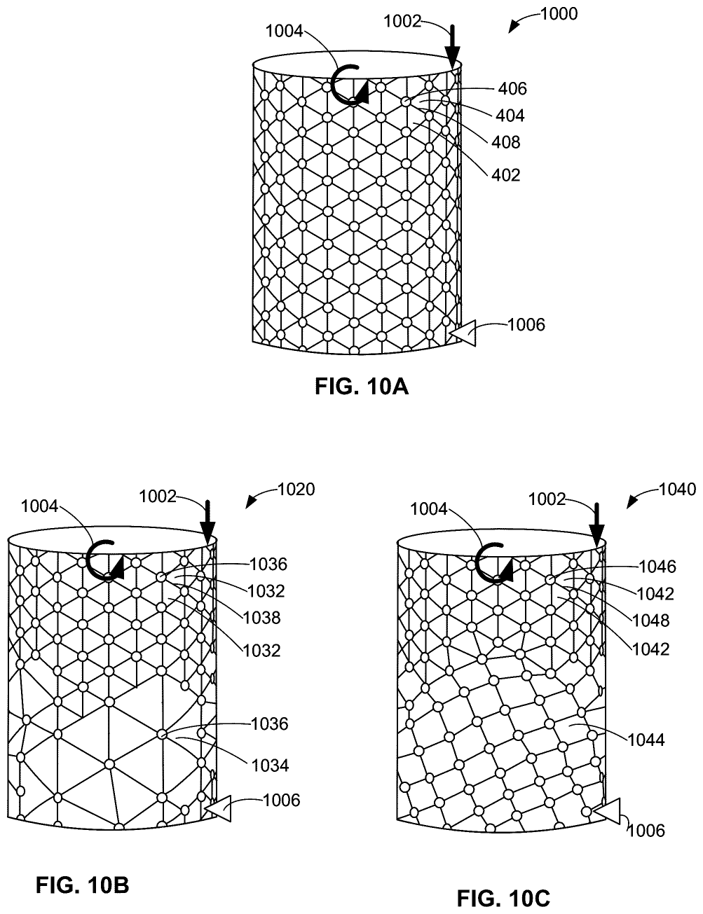

FIG. 10A is a front view of an example cylindrical structure model 1000 including the stiffening patterns of FIGS. 4A-9C. The cylindrical structure model 1000 can be implemented in connection with a Finite Element Analysis (FEA) and/or a Failure Mode and Effects Analysis (FMEA) discussed in further detail in connection with FIG. 10. Generally, the cylindrical structure model 1000 includes the same features as the cylindrical structure 800 of FIG. 8, save for the flanges 810, 812 (FIG. 8). Further, the geometry of the unit cells 402, 404, the nodes 406, the transition edges 408, and, more generally, the cylindrical structure model 1000 are not to scale with the cylindrical structure 800. The cylindrical structure model 1000 includes a thickness of 0.9 in. of the transition edges 408 (e.g., the fourth distance 510 of FIG. 5). The cylindrical structure model 1000 includes a thickness of 0.032 in. of the recessed unit cells 402 and the protruding unit cells 404 (e.g., the third distance 508 of FIG. 5). The cylindrical structure model 1000 includes a triangle height of 1.57 in. (e.g., the first distance 420 of FIG. 4B). The cylindrical structure model 1000 includes a radial height of 0.185 in. (e.g., the second distance 506 of FIG. 5). A compressive load 1002 and a moment 1004 (e.g., an overturning moment) can be applied to the cylindrical structure model 1000, while the cylindrical structure model is constrained by a fixed support 1006. In the illustrated example of FIGS. 10A-10C, the compressive load 1002 and the moment 1004 emulate the induced load and moment in the bypass duct of a low-bypass type and/or high-bypass type turbofan.

FIG. 10B is a front view of an example cylindrical structure model 1020 including the stiffening patterns of FIGS. 4A-9C. The cylindrical structure model 1020 is similar to the example cylindrical structure 1000 of FIG. 10A but has unit cells of varying, rather than uniform, size. Further, the geometry of the unit cells 1032, 1034, the nodes 1036, the transition edges 1038, and, more generally, the cylindrical structure model 1020 are not to scale with the example cylindrical structure 1000. The unit cells 1032 and 1034 are both unit cells, even though unit cell 1034 is a larger trigonal shape than unit cell 1032. This variation in unit cell size is useful in creating structures of different sizes at different ends, for example.

FIG. 10C is a front view of an example cylindrical structure model 1040 including the stiffening patterns of FIGS. 4A-9C, in which the shape of the unit cells vary. Generally, the cylindrical structure model 1040 includes the same features as the cylindrical structure 1000 of FIG. 10A, but unit cell shape varies. Further, the geometry of the unit cells 1042, 1044, the nodes 1046, the transition edges 1048, and, more generally, the cylindrical structure model 1040 are not to scale with the example cylindrical structure 1000. The unit cell 1042 is a small trigonal unit cell, while the unit cell 1044 is a larger quadrilateral unit cell. The example structure model 1040 illustrates that the unit cells 1042, 1044 do not have to be the same shape to create a surface. Transition can occur between multiple different unit cells, for example. For example, the unit cell 1044 can be a hexagonal unit cell with a transition into a pentagonal unit cell. This variation in unit cell shape is useful in creating structures with transitions, for example.

As such a variety of stiffening patterns can be formed in the part 102 using the tool 108 as supported by the structure 110. Formation can be controlled by the controller 130, and the part 102, tool 108, and/or support structure 110 can be moved using the table 120 (e.g., manually and/or controlled by the controller 130). The controller 130 can be programmed with a desired stiffening pattern and then used to position the part 102, the tool 108, and/or the support structure 110 to form the pattern in/on the part 102.

FIG. 11 is a block diagram of an example processor platform 1200 structured to execute the instructions of FIG. 1 to drive and/or otherwise control an additive manufacturing device (e.g., PBF, EBM, CSAM, SLS, DMLS or tool, etc.) to execute an example manufacturing process to form an example aircraft component and/or an engine component (e.g., a structure) including the stiffening pattern for unit cell structures of FIGS. 3-10C. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 1112 implements the controller 130 to execute the example stiffening pattern formation process of FIG. 2 including the method 200.

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), a Bluetooth® interface, a near field communication (NFC) interface, and/or a PCI express interface.

In the illustrated example, one or more input devices 1122 are connected to the interface circuit 1120. The input device(s) 1122 permit(s) a user to enter data and/or commands into the processor 1112. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1120 of the illustrated example, thus, typically includes a graphics driver card, a graphics driver chip and/or a graphics driver processor.

The interface circuit 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1126. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, redundant array of independent disks (RAID) systems, and digital versatile disk (DVD) drives.

The machine executable instructions 1132 of FIG. 11 may be stored in the mass storage device 1128, in the volatile memory 1114, in the non-volatile memory 1116, and/or on a removable non-transitory computer readable storage medium such as a CD or DVD.

As such, the above deformation equipment and associate method(s) can be used to produce one or more zones of deformation in a part to form depression(s), which intermix with non-depressed portion(s) to form a stiffening structure, such as an isopanel/isogrid, etc. For example, the tool can include a burnishing tool with a burnishing ball in a socket (e.g., to pass over the surface of the part in one or more passes of a rolling motion to provide deep compression, etc.), the tool manipulatable to apply the ball against a surface (e.g., an inner surface or an outer surface) of the part to deform the surface. The tool can induce a layer of compressive residual stress in the surface of the part, for example, to improve fatigue-resistance and stress performance of the part beyond what is possible with prior tools and approaches, for example.

From the foregoing, it will be appreciated that example methods, apparatus and articles of manufacture have been disclosed to form stiffening patterns for unit cell structures including opposing unit cells joined at nodes. Examples disclosed have increased aerodynamic properties compared to conventional isogrid structures and can be formed using additive manufacturing processes such as PBF, EBM, CSAM, SLS, DMLS or tool, etc.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

Further aspects of the invention are provided by the subject matter of the following clauses:

An apparatus including: a frame to hold a part; a tool to apply a force to the part; and a support structure to be positioned opposite the tool to support the part when the force is applied to the part by the tool.

The apparatus of any preceding clause, wherein the tool is to be positioned on an inside surface of the part, and wherein the support structure is to be positioned on an outside surface of the part.

The apparatus of any preceding clause, wherein the frame includes at least a first frame to support a first end of the part and a second frame to support a second end of the part.

The apparatus of any preceding clause, wherein the tool includes at least one of a low plasticity burnishing tool or a stir friction welding tool.

The apparatus of any preceding clause, further including a clamp to position the tool and the support structure with respect to the part.

The apparatus of any preceding clause, wherein the part is an isopanel.

The apparatus of any preceding clause, further including processor circuitry to control the tool.

The apparatus of any preceding clause, wherein the processor is programmable to dynamically adjust a geometry of the part during operation of the tool.

The apparatus of any preceding clause, further including a multi-axis stage.

The apparatus of any preceding clause, further including a turntable.

A method of operating the apparatus of any preceding clause to form the part.

At least one computer-readable medium storing instructions which, when executed, cause processor circuitry to execute the method of any preceding clause.

A system including: means for holding a part; means for applying a force to the part; and means for supporting opposite the means for applying the force.

An example apparatus includes: a frame to hold a part; a tool positioned adjacent a first surface of the part to apply a force to the first surface of the part to deform the part; and a support structure to be positioned adjacent a second surface of the part, the support structure positioned opposite the tool to support the part when the force is applied to the part by the tool, the tool forming a stiffening pattern in the part.

The apparatus of any preceding clause, wherein the first surface is an inside surface of the part, and wherein the second surface is an outside surface of the part.

The apparatus of any preceding clause, wherein the frame includes at least a first frame to support a first end of the part and a second frame to support a second end of the part.

The apparatus of any preceding clause, wherein the tool includes at least one of a low plasticity burnishing tool or a friction stir welding tool.

The apparatus of any preceding clause, further including a clamp to position the tool and the support structure with respect to the part.

The apparatus of any preceding clause, wherein the part is an isopanel.

The apparatus of any preceding clause, wherein the part is axisymmetric.

The apparatus of any preceding clause, wherein the part is cylindrical.

The apparatus of any preceding clause, wherein the part is at least one of an engine casing or an engine duct.

The apparatus of any preceding clause, further including processor circuitry to control the tool.

The apparatus of any preceding clause, wherein the processor circuitry is programmable to dynamically adjust a geometry of the part during operation of the tool.

The apparatus of any preceding clause, further including a multi-axis stage to position the part.

The apparatus of any preceding clause, further including a turntable to rotate the part.

The apparatus of any preceding clause, wherein the frame is to apply at least one of a strain or a tension to the part.

An example method of operating the apparatus of any preceding clause includes: applying the force to the first surface of the part using the tool positioned adjacent the first surface of the part to deform the part, the part supported by the support structure; and adjusting a position of at least one of the tool or the part and repeating the application of the force to form a stiffening pattern in the part.

The method of any preceding clause, wherein the adjusting the position of the tool is in response to a change in geometry.

The method of any preceding clause, wherein the change in geometry is identified in a file specifying the stiffening pattern.

The method of any preceding clause, wherein the first surface is an inside surface of the part and wherein the second surface is an outside surface of the part.

At least one example computer-readable medium including instructions which, when executed, cause processor circuitry to at least: apply a force to a first surface of a part using a tool positioned adjacent a first surface of the part to deform the part, the part supported by a support structure positioned adjacent a second surface of the part; and adjust a position of at least one of the tool or the part and repeating the application of the force to form a stiffening pattern in the part.

The at least one computer-readable medium of any preceding clause, wherein the first surface is an inside surface of the part and wherein the second surface is an outside surface of the part.

The at least one computer-readable medium of any preceding clause, wherein the adjusting the position of the tool is in response to a change in geometry.

The at least one computer-readable medium of any preceding clause, wherein the change in geometry is identified in a file specifying the stiffening pattern.

The following claims are hereby incorporated into this Detailed Description by this reference, with each claim standing on its own as a separate embodiment of the present disclosure.

What is claimed is:

1. An apparatus comprising:
a frame to hold a part;
a tool positioned adjacent a first surface of the part to apply a force to the first surface of the part to deform the part; and
a support structure to be positioned adjacent a second surface of the part, the support structure positioned opposite the tool to support the part when the force is applied to the part by the tool, the tool forming a stiffening pattern in the part.

2. The apparatus of claim 1, wherein the first surface is an inside surface of the part, and wherein the second surface is an outside surface of the part.

3. The apparatus of claim 1, wherein the frame includes at least a first frame to support a first end of the part and a second frame to support a second end of the part.

4. The apparatus of claim 1, wherein the tool includes at least one of a low plasticity burnishing tool or a friction stir welding tool.

5. The apparatus of claim 1, further including a clamp to position the tool and the support structure with respect to the part.

6. The apparatus of claim 1, wherein the part is an isopanel.

7. The apparatus of claim 1, wherein the part is axisymmetric.

8. The apparatus of claim 7, wherein the part is cylindrical.

9. The apparatus of claim 8, wherein the part is at least one of an engine casing or an engine duct.

10. The apparatus of claim 1, further including processor circuitry to control the tool.

11. The apparatus of claim 10, wherein the processor circuitry is programmable to dynamically adjust a geometry of the part during operation of the tool.

12. The apparatus of claim 1, further including at least one of a turntable or a multi-axis stage to position the part.

13. The apparatus of claim 1, wherein the frame is to apply at least one of a strain or a tension to the part.

14. A method of operating the apparatus of claim 1, the method comprising:
applying the force to the first surface of the part using the tool positioned adjacent the first surface of the part to deform the part, the part supported by the support structure; and
adjusting a position of at least one of the tool or the part and repeating the application of the force to form a stiffening pattern in the part.

15. The method of claim 14, wherein the first surface is an inside surface of the part and wherein the second surface is an outside surface of the part, and wherein the adjusting the position of the tool is in response to a change in geometry.

16. The method of claim 15, wherein the change in geometry is identified in a file specifying the stiffening pattern.

17. At least one computer-readable medium comprising instructions which, when executed, cause processor circuitry to at least:
apply a force to a first surface of a part using a tool positioned adjacent a first surface of the part to deform the part, the part supported by a support structure positioned adjacent a second surface of the part; and
adjust a position of at least one of the tool or the part and repeating the application of the force to form a stiffening pattern in the part.

18. The at least one computer-readable medium of claim 17, wherein the first surface is an inside surface of the part and wherein the second surface is an outside surface of the part.

19. The at least one computer-readable medium of claim 17, wherein the adjusting the position of the tool is in response to a change in geometry.

20. The at least one computer-readable medium of claim 19, wherein the change in geometry is identified in a file specifying the stiffening pattern.
